(19) United States
(12) Patent Application Publication
(10) Pub. No.: US 2006/0151607 A1
(43) Pub. Date: Jul. 13, 2006

(54) Document scan system, document transfer system, document transfer method, and storage medium readable by a computer

(76) Inventors: Kazunori Horikiri, Tokyo (JP); Yoshiki Watanabe, Tokyo (JP)

Correspondence Address: GAUTHIER & CONNORS, LLP, 225 FRANKLIN STREET, BOSTON, MA, 02110, US

(21) Appl. No.: 11/369,398

(22) Filed: Mar. 7, 2006

(30) Foreign Application Priority Data
Nov. 5, 2004 (JP) 2004-322607

(51) Int. Cl. G06K 7/10; G06F 17/00

(52) U.S. Cl. 235/454; 235/375

(57) ABSTRACT

A document scan system includes scanners, provided in a plurality of locations, that scan a document to generate and store an electronic document; information terminals, provided in the plurality of locations, that receive an input of a user identification information for identifying the user; a document access unit that, subsequent to input of a user identification information into an information terminal, acquires an electronic document from a scanner provided at a location in which the information terminal is provided; and a document registration unit that stores the electronic document acquired by the document access unit into a storage region assigned to a user indicated by the user identification information.

### BACKGROUND

1. Technical Field

The present invention relates to a document scan system including scanners provided in respective multiple locations.

2. Related Art

A digital multifunction machine including a scanner function may be used, for example, to scan a paper document and to load the obtained electronic document (hereinafter may be referred to as the “scanned document”) into the user's own personal computer (PC).

When using the multifunction machine in the manner described above, the user sets up his PC in advance by installing a scanner driver in the PC, designating in the PC the address of the multifunction machine on the network, and the like, such that access can be made to the multifunction machine from the PC. Further, the user creates in advance a memory section (known as a security box) assigned to himself within the multifunction machine, such that his scanned documents can be retained inside the multifunction machine. A user ID and a password are often assigned to the security box so as to ensure security. When the user designates his security box and scans a paper document, the scanned document is retained in the designated security box. Subsequently, the user accesses the multifunction machine from the PC by submitting the user ID and the password, and loads into the PC the scanned document retained in the security box.

In an office or the like, multifunction machines are often provided in multiple locations (including conference rooms and the like). In such an environment, when a user wishes to obtain a scanned document from a paper document using a multifunction machine provided at a location where the user is visiting for the first time, the user must perform the following preparations in advance. The user must first determine the model of the multifunction machine, and install in his PC driver software corresponding to the model. The user must also determine the address of the multifunction machine on the network, and designate this address in the PC. Further, the user must create his own security box within the multifunction machine, or alternatively, acquire information (user ID and password or the like) concerning an existing security box.

As such, in a conventional environment having scanners provided in multiple locations, before using the scanners a user must perform the above-described steps separately for the respective scanners in different locations.

### SUMMARY

According to one aspect of the present invention, there is provided a document scan system, having: scanners, provided in a plurality of locations, that scan a document to generate and store an electronic document; information terminals, provided in the plurality of locations, that receive an input of a user identification information for identifying the user; a document access unit that, subsequent to input of a user identification information into an information terminal, acquires an electronic document from a scanner provided at a location in which the information terminal is provided; and a document registration unit that stores the electronic document acquired by the document access unit into a storage region assigned to a user indicated by the user identification information.

According to another aspect of the present invention, there is provided a document scan system, having: scanners, provided in a plurality of locations, that scan a document to generate and store an electronic document; information terminals, provided in the plurality of locations, that receive an input of user identification information for identifying a user; a document transfer unit that transfers an electronic document stored in a scanner to a storage region assigned to a user; a scanner access information table that shows a correlation between a location and scanner access information which is required for acquiring an electronic document stored in a scanner provided at the location; and a storage region access information table that shows a correlation between user identification information and storage region access information which is required for storing an electronic document into a storage region assigned to a user indicated by the user identification information; wherein the information terminal notifies the document transfer unit of information of a location in which the information terminal is provided, along with the input user identification information; and the document transfer unit acquires, from a scanner provided in the location indicated by the notified information, an electronic document stored in the scanner based on the scanner access information which is acquired according to the scanner access information table, and stores the acquired electronic document into a storage region assigned to a user indicated by the notified user identification information, based on the storage region access information which is acquired according to the storage region access information table.

According to another aspect of the present invention, there is provided a document transfer system that transfers an electronic document stored in a scanner in an environment in which scanners are provided in a plurality of locations, the system having: information terminals, provided in the plurality of locations, that receive a user identification information for identifying the user; a document acquiring unit that, subsequent to input of a user identification information into an information terminal, acquires an electronic document from a scanner provided at a location in which the information terminal is provided; and a document registration unit that stores the acquired electronic document into a storage region assigned to a user indicated by the user identification information.

According to another aspect of the present invention, there is provided a document transfer method for transferring an electronic document stored in a scanner in an environment in which scanners are provided in a plurality of locations, the method having: receiving, via information terminals provided in the plurality of locations, a user identification information for identifying a user; subsequent to input of a user identification information into an information terminal, acquiring, from a scanner provided at a location in which the information terminal is provided, an electronic document; and storing the acquired electronic document into a storage region assigned to a user indicated by the user identification information.

According to another aspect of the present invention, there is provided a storage medium readable by a computer, the storage medium storing a program of instructions executable by the computer to perform a function for transferring an electronic document stored in a scanner in an environment in which scanners are provided in a plurality of locations, the function having: receiving, via information terminals provided in the plurality of locations, a user identification information for identifying a user; subsequent to input of a user identification information into an information terminal, acquiring, from a scanner provided at a location in which the information terminal is provided, an electronic document; and storing the acquired electronic document into a storage region assigned to a user indicated by the user identification information.

### BRIEF DESCRIPTION OF THE DRAWINGS

Embodiments of the present invention will be described in detail by reference to the following figures, wherein:

FIG. 1 is a block diagram showing the overall configuration of a document scan system according to a first embodiment of the present invention;

FIG. 2 is a diagram showing data registered in a database;

FIG. 3 is a block diagram showing the configuration of an information terminal;

FIG. 4 is a block diagram showing the configuration of a document transfer server;

FIG. 5 is a flowchart showing an operation sequence of the document scan system;

FIG. 6 is a block diagram showing the overall configuration of a document scan system according to a second embodiment of the present invention;

FIG. 7 is a diagram showing data registered in a database;

FIG. 8 is a block diagram showing the configuration of an information terminal;

FIG. 9 is a block diagram showing the configuration of a document transfer server; and

FIG. 10 is a flowchart showing an operation sequence of the document scan system.

### DETAILED DESCRIPTION

Embodiments of the present invention are described below by reference to the drawings.

### FIRST EMBODIMENT

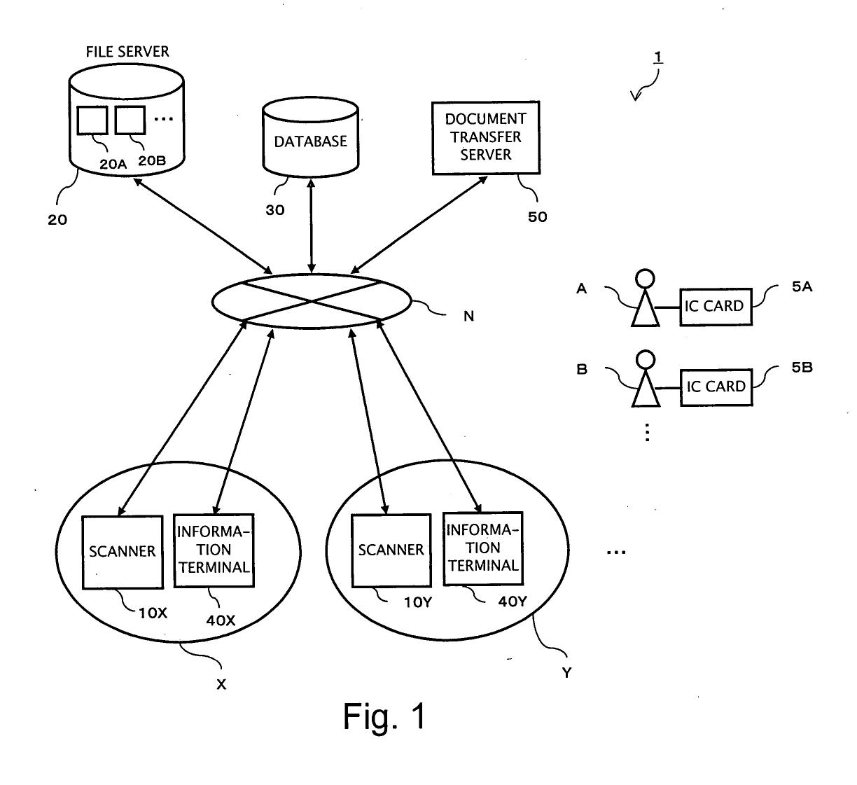

FIG. 1 is a block diagram showing the overall configuration of a document scan system 1 according to a first embodiment of the present invention. The document scan system 1 includes scanners provided in multiple locations, and serves to transfer an electronic document, which a user scanned by using a scanner at a desired location, to a storage region assigned to that user in advance. The present embodiment refers to an example in which the document scan system 1 is applied to an electronic conferencing system. It should be noted that the document scan system 1 need not be applied to an electronic conferencing system.

In FIG. 1, the document scan system 1 includes scanners 10 provided in respective multiple locations, a file server 20, a database 30, information terminals 40 provided in the above-noted multiple locations, respectively, and a document transfer server 50. These devices are interconnected in a wired or wireless manner via a network N such as the Internet or a LAN. In FIG. 1, two conference rooms X and Y are shown as the multiple locations, and these rooms are provided with scanners 10X, 10Y and information terminals 40X, 40Y, respectively. Further, location identifiers RID_{X} and RID_{Y} for identifying the respective locations are assigned to the conference rooms X, Y. It should be noted that the term “conference room” referred to herein denotes not only the actual space inside the room, but also areas in the vicinity of the room. Accordingly, a scanner 10 may, for example, be placed outside the actual room space of the conference room.

With respect to each user of the document scan system 1, a contactless IC card 5 for user authentication is issued in advance. Each user's IC card 5 has stored therein a user identifier for identifying the user. FIG. 1 shows two users A, B owning IC cards 5A, 5B, respectively. User identifiers UID_{A}, UID_{B} are stored in the IC cards 5A, 5B, respectively. Although the IC cards 5 are contactless in view of convenience in this embodiment, the IC cards 5 may be of a contact type.

Although two conference rooms are shown in FIG. 1 as an example case, in many cases a greater number of conference rooms are actually included, with two being the minimum number of conference rooms. Further, although two users are shown in FIG. 1 as an example case, in many cases a greater number of users are actually included, with one being the minimum number of users.

<Scanners>

Each scanner 10 is a device which scans an original copy to generate and retain an electronic document. In an embodiment, the scanner 10 is a digital multifunction machine which also includes functions other than the scan function, such as a print function and a facsimile function. Specifically, the scanner 10 optically reads an image of an original document on paper or the like by means of a reading system such as a platen scan system or a sheet feed scan system, so as to convert the image into image data. The scanner 10 then creates an electronic document having a file format (referred to as “scanned document”) from the converted image data, and retains the created scanned document in a memory section (for example, a security box) within the scanner 10.

For security purposes, a read restriction is set for the memory section within the scanner 10. In cases where the scanner 10 has received from an external device a request for reading out the scanned document, the scanner 10 permits the readout when predetermined readout authority information is submitted, and disallows the readout when this information is not submitted. In the present example, the read authority information is a user name and a password. User name U_{X} and password P_{X} are set for the scanner 10X, and user name U_{Y} and password P_{Y} are set for the scanner 10Y.

<File Server>

The file server 20 is a server which stores and manages data, and includes multiple storage regions allocated to the respective users. In FIG. 1, a storage region 20A for user A and a storage region 20B for user B are shown as examples of the multiple storage regions.

For security purposes, a write restriction and a read restriction are set for each storage region. In a case where the file server 20 has received from an external device a request for writing data in a certain storage region, the file server 20 permits the writing when write authority information assigned to the storage region is submitted, and disallows the writing when this information is not submitted. Further, in a case where the file server 20 has received from an external device a request for reading out data in a certain storage region, the file server 20 permits the readout when read authority information assigned to the storage region is submitted, and disallows the readout when this information is not submitted. In the present example, each of the write authority information and the read authority information includes a user name and a password. For the storage region 20A, user name UW_{A} and password PW_{A} are designated as the write authority information, and user name UR_{A} and password PR_{A} are designated as the read authority information. For the storage region 20B, user name UW_{B} and password PW_{B} are designated as the write authority information, and user name UR_{B} and password PR_{B} are designated as the read authority information.

<Database>

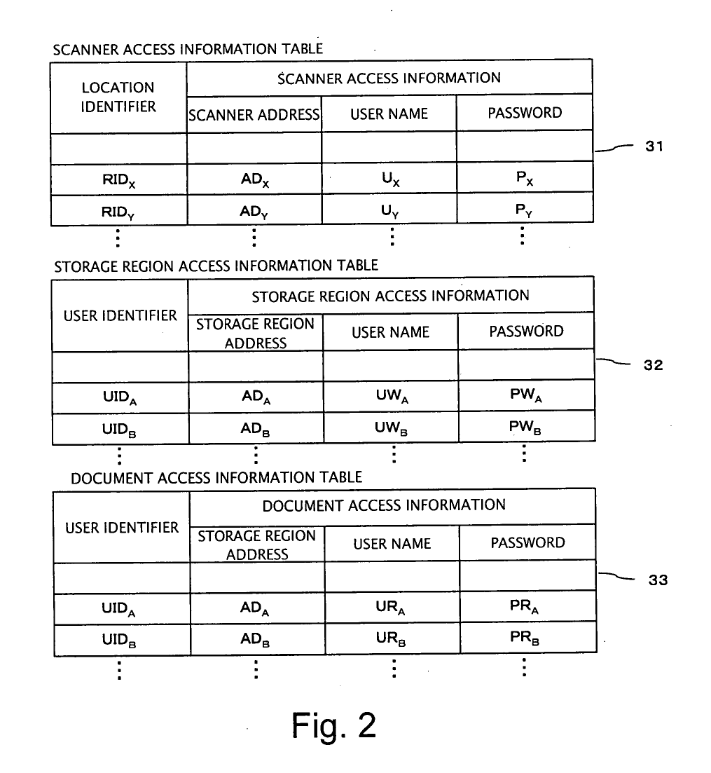

The database 30 stores various data employed in the document scan system 1. FIG. 2 shows tables of data registered in the database 30. According to the present embodiment, the database 30 has stored therein a scanner access information table 31, a storage region access information table 32, and a document access information table 33, as can be seen in FIG. 2.

The scanner access information table 31 is a table which shows a correlation between each location identifier and corresponding scanner access information required for reading out data from the scanner 10 provided at the location denoted by the location identifier. In the present embodiment, the scanner access information includes a scanner address (such as an IP address) denoting the position of the scanner 10 on the network, and the read authority information (user name and password) corresponding to the read restriction of the scanner 10.

The storage region access information table 32 is a table which shows a correlation between each user identifier and corresponding storage region access information required for writing data into the storage region of the user denoted by the user identifier. In the present embodiment, the storage region access information includes a storage region address (such as a URL) denoting the position of the storage region on the network, and the write authority information (user name and password) corresponding to the write restriction of the storage region.

The document access information table 33 is a table which shows a correlation between each user identifier and corresponding document access information required for reading out data from the storage region of the user denoted by the user identifier. In the present embodiment, the document access information includes a storage region address denoting the position of the storage region on the network, and the read authority information (user name and password) corresponding to the read restriction of the storage region.

<Information Terminals>

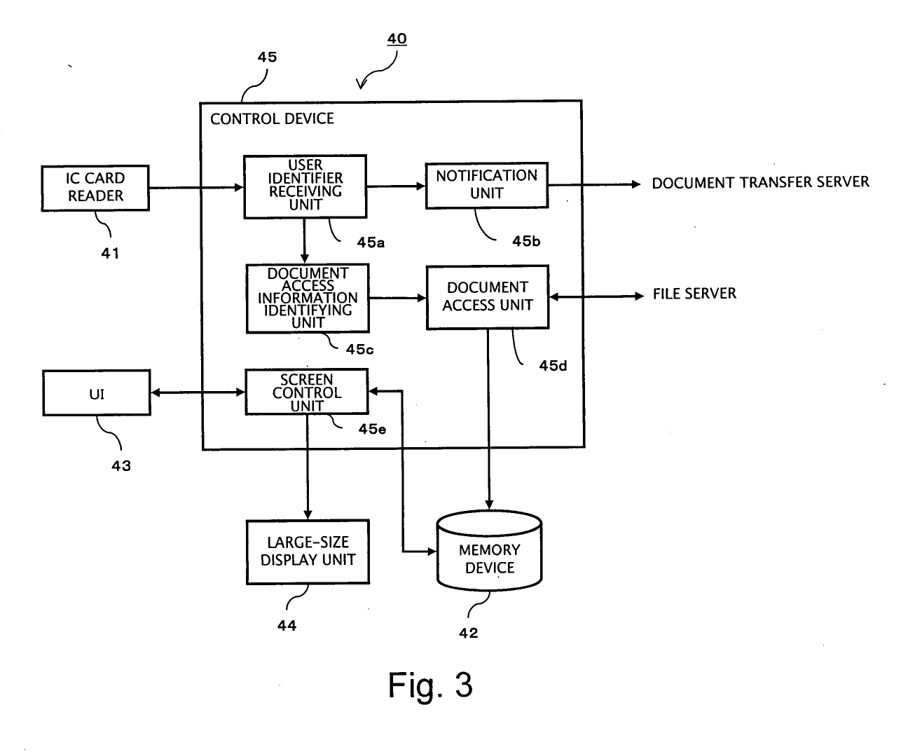

Each information terminal 40 may be a device of any type, so long as the device allows a user to input therein a user identifier for identifying the user. In the present embodiment, the information terminal 40 is an information terminal for an electronic conferencing system. FIG. 3 is a diagram showing the configuration of the information terminal 40. As can be seen in FIG. 3, the information terminal 40 includes an IC card reader 41, a memory device 42, a user interface (UI) 43, a large-size display unit 44, and a control device 45.

The IC card reader 41 is a contactless reading device for reading out from a user's IC card 5 the user identifier stored therein. The memory device 42 is a hard disk device or the like for storing data of scanned documents and the like. The UI 43 is an interface for providing various information to the user (mainly to the speaker in the conference) and receiving operation inputs from the user. In the present embodiment, the UI 43 is a touch panel display unit having a small size (15-inch display). The large-size display unit 44 is an electronic whiteboard which can be operated by touching the screen with a finger. Characters and graphics can be drawn on the screen of the large-size display unit 44 by means of an electronic pen.

The control device 45 is a device such as a computer for performing overall control of the information terminal 40 and for executing various types of information processing. The control device 45 includes, as functional blocks, a user identifier receiving unit 45a, a notification unit 45b, a document access information identifying unit 45c, a document access unit 45d, and a screen control unit 45e.

The user identifier receiving unit 45a receives a user identifier read out by the IC card reader 41, and supplies the received user identifier to the notification unit 45b and the document access information identifying unit 45c.

The notification unit 45b transmits to the document transfer server 50 the user identifier received from the user identifier receiving unit 45a, along with the location identifier assigned to the location at which the information terminal 40 is placed. The location identifier is assumed to have been registered in advance in a predetermined memory section inside the information terminal 40.

The document access information identifying unit 45c identifies document access information which is correlated in advance to the user identifier received from the user identifier receiving unit 45a. In the present embodiment, the document access information identifying unit 45c refers to the document access information table 33 within the database 30 so as to identify the document access information correlated with the received user identifier. The document access information identifying unit 45c supplies the identified document access information to the document access unit 45d.

After receiving the document access information (including the storage region address and the read authority information), the document access unit 45d uses the document access information to acquire from the file server 20 a scanned document stored therein. Specifically, at predetermined timings, the document access unit 45d accesses the storage region submitting the read authority information to the storage region denoted by the storage region address, and acquires a scanned document when the scanned document is stored in the accessed storage region. For example, after receiving the document access information, the document access unit 45d monitors the storage region by periodically accessing the storage region, and acquires the scanned document when the scanned document is stored into the storage region. In an embodiment, the document access unit 45d starts or stops monitoring the storage region in accordance with an instructing operation of the UI 43 by the user. It should be noted that the timing, frequency, duration, or the like at which the document access unit 45d accesses the storage region can be set as appropriate. The document access unit 45d stores into the memory device 42 the scanned document acquired from the file server 20.

The screen control unit 45e allows the scanned document stored in the memory device 42 to be displayed on the large-size display unit 44. In the present embodiment, the screen control unit 45e first controls the UI 43 to display a screen prompting the user to select which of one or more scanned documents stored within the memory device 42 should be displayed on the large-size display unit 44, receives the user's input selecting a scan document via this screen on the UI 43, and causes the large-size display unit 44 to display the selected scanned document. The screen control unit 45e may be configured to display a scanned document on the large-size display unit 44 immediately after completion of the storing process of the scanned document into the memory device 42.

In the present embodiment, the above-described functional blocks 45a-45e are implemented by a CPU executing a program stored within a storage medium such as ROM. It should be noted that no limitations are imposed on the specific configurations by which the functional blocks 45a-45e are to be implemented.

<Document Transfer Server>

The document transfer server 50 is a server which transfers a scanned document retained within each scanner 10 to a user's storage region within the file server 20, and may be configured from a computer. The document transfer server 50 has two main functions. The first function is a document access function, in which, subsequent to input of a user identifier of a user into an information terminal 40 provided in one of the multiple locations, the document transfer server 50 uses scanner access information correlated in advance with the location so as to acquire from the scanner 10 belonging to the location a scanned document retained within the scanner 10. The second function is a document registration function, in which the document transfer server 50 uses storage region access information correlated in advance with the user identifier of that user so as to store the scanned document acquired by the document access function into the storage region assigned to the user.

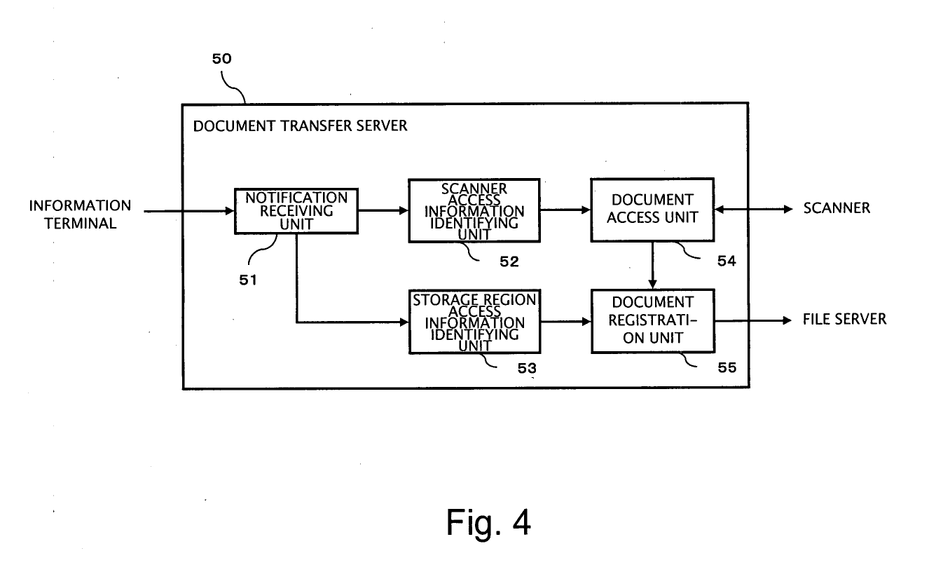

FIG. 4 is a block diagram showing the configuration of the document transfer server 50. In FIG. 4, the document transfer server 50 includes, as functional blocks, a notification receiving unit 51, a scanner access information identifying unit 52, a storage region access information identifying unit 53, a document acquiring unit 54, and a document registration unit 55.

The notification receiving unit 51 receives notification of a user identifier and a location identifier from an information terminal 40. Then, the notification receiving unit 51 supplies the location identifier to the scanner access information identifying unit 52, while supplying the user identifier to the storage region access information identifying unit 53.

The scanner access information identifying unit 52 identifies scanner access information correlated in advance with the location identifier received from the notification receiving unit 51. In the present embodiment, the scanner access information identifying unit 52 refers to the scanner access information table 31 within the database 30 so as to identify the scanner access information corresponding to the location identifier. The scanner access information identifying unit 52 supplies the identified scanner access information to the document access unit 54.

The storage region access information identifying unit 53 identifies storage region access information correlated in advance with the user identifier received from the notification receiving unit 51. In the present embodiment, the storage region access information identifying unit 53 refers to the storage region access information table 32 within the database 30 so as to identify the storage region access information corresponding to the user identifier. The storage region access information identifying unit 53 supplies the identified storage region access information to the document registration unit 55.

The document access unit 54 receives the scanner access information (including a scanner address and read authority information), and then uses the scanner access information to acquire from the scanner 10 a scanned document retained therein. Specifically, at predetermined timings, the document access unit 54 submits the read authority information to the scanner 10 denoted by the scanner address so as to access the scanner 10, and acquires a scanned document when the scanned document is retained in the accessed scanner 10. For example, after receiving the scanner access information, the document access unit 54 monitors the scanner 10 by periodically accessing the scanner 10, and acquires the scanned document when the scanned document is stored into the scanner 10. In an embodiment, the document access unit 54 starts or stops monitoring the scanner 10 in accordance with an instructing operation of the UI 43 by the user. It should be noted that the timing, frequency, duration, or the like at which the document access unit 54 accesses the scanner 10 can be set as appropriate. The document access unit 54 supplies the scanned document acquired from the scanner 10 into the document registration unit 55.

The document registration unit 55 uses the storage region access information (including a storage region address and write authority information) received from the storage region access information identifying unit 53 to store into the file server 20 the scanned document acquired by the document access unit 54. Specifically, the document registration unit 55 submits the write authority information to the storage region denoted by the storage region address, so as to access the storage region and store the scanned document therein.

In the present embodiment, the above-described functional blocks 51-55 are implemented by a CPU executing a program stored within a storage medium such as ROM. It should be noted that no limitations are imposed on the specific configurations by which the functional blocks 51-55 are to be implemented.

<Operation of Document Scan System>

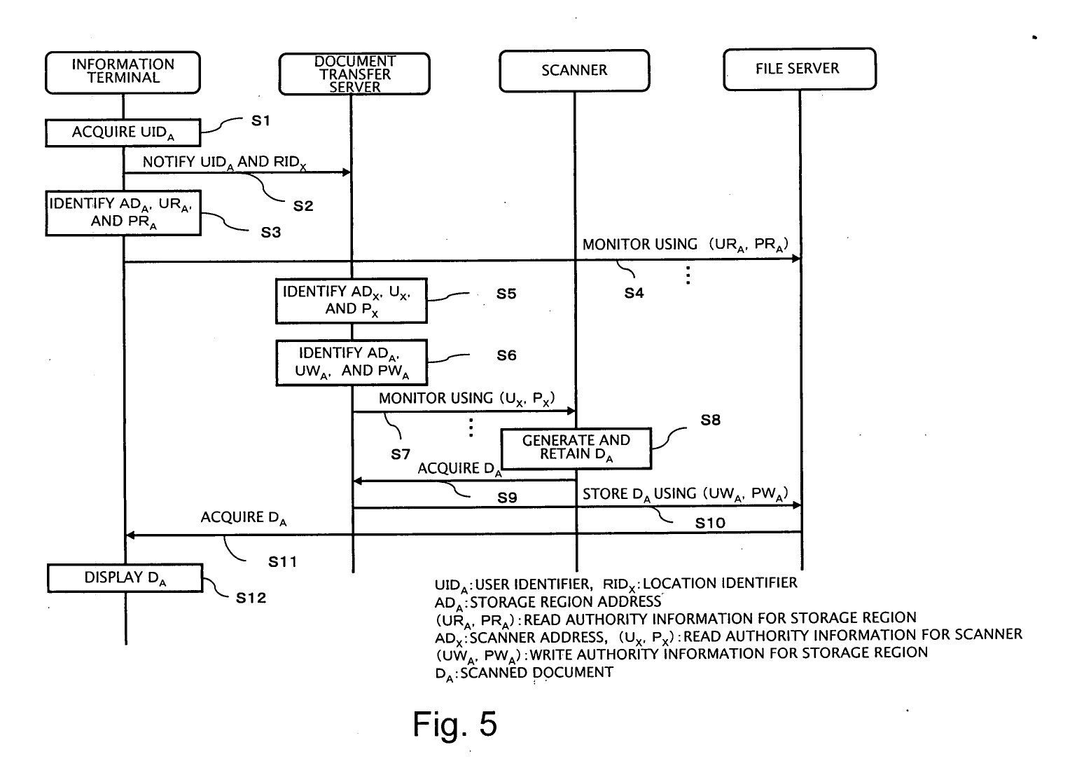

FIG. 5 is a flowchart showing an operation sequence of the document scan system 1. FIG. 5 illustrates a case in which the user A employs the scanner 10X in the conference room X. The operation of the document scan system 1 is described in detail below by reference to FIG. 5.

When a conference is to be held in the conference room X, the user A who is a speaker at the conference first holds his IC card 5A over the IC card reader 41 of the information terminal 40X placed in the conference room X.

In the information terminal 40X, when the IC card 5A is held over the IC card reader 41, the user identifier receiving unit 45a acquires, via the IC card reader 41, the user identifier UID_{A} stored in the IC card 5A (S1). The user identifier receiving unit 45a then supplies the user identifier UID_{A} to the notification unit 45b and the document access information identifying unit 45c.

When receiving the user identifier UID_{A}, the notification unit 45b transmits to the document transfer server 50 the user identifier UID_{A} along with the location identifier RID_{X} registered in advance in the information terminal 40X (S2).

Meanwhile, upon receiving the user identifier UID_{A}, the document access information identifying unit 45c refers to the document access information table 33 within the database 30, and acquires document access information (AD_{A}, UR_{A}, PR_{A}) corresponding to the user identifier UID_{A} (S3). The acquired document access information is supplied to the document access unit 45d.

When receiving the document access information (AD_{A}, UR_{A}, PR_{A}), the document access unit 45d starts periodically accessing the storage region 20A denoted by the storage region address AD_{A} (S4). This accessing process involves submitting the read authority information (UR_{A}, PR_{A}) to the storage region 20A.

In the document transfer server 50, upon receiving the user identifier UID_{A} and the location identifier RID_{X} from the information terminal 40X, the notification receiving unit 51 supplies the location identifier RID_{X} to the scanner access information identifying unit 52, and supplies the user identifier UID_{A} to the storage region access information identifying unit 53.

Upon receiving the location identifier RID_{X}, the scanner access information identifying unit 52 refers to the scanner access information table 31 within the database 30, and acquires scanner access information (AD_{X}, U_{X}, P_{X}) corresponding to the location identifier RID_{X} (S5). The acquired scanner access information is supplied to the document access unit 54.

Meanwhile, upon receiving the user identifier UID_{A}, the storage region access information identifying unit 53 refers to the storage region access information table 32 within the database 30, and acquires storage region access information (AD_{A}, UW_{A}, PW_{A}) corresponding to the user identifier UID_{A} (S6). The acquired storage region access information is supplied to the document registration unit 55.

Upon receiving the scanner access information (AD_{X}, U_{X}, P_{X}), the document access unit 54 starts periodically accessing the scanner 10X denoted by the scanner address AD_{X} (S7). This accessing process involves submitting the read authority information (U_{X}, P_{X}) to the scanner 10X.

During the conference, when it is desired to display on the large-size display unit 44 of the information terminal 40X a paper document owned by a participant in the conference, the user A sets the paper document on the scanner 10X and presses the scan start button (not shown) of the scanner 10X. In response, the scanner 10X reads the image of the paper document set thereon so as to generate a scanned document D_{A}, and stores the scanned document D_{A} within the internal memory section (S8).

In the document transfer server 50, the document access unit 54 is monitoring the scanner 10X by periodically accessing the scanner 10X, and reads out the scanned document D_{A} from the scanner 10X when the scanned document D_{A} is stored into the scanner 10X (S9). Although a read restriction is set for the memory section of the scanner 10X, readout of the scanned document D_{A} by the document access unit 54 is permitted, because the document access unit 54 accesses the scanner 10X by submitting the read authority information (U_{X}, P_{X}). The document access unit 54 supplies the acquired scanned document D_{A} to the document registration unit 55.

Upon receiving the scanned document D_{A}, the document registration unit 55 accesses the storage region 20A, which is denoted by the storage region address AD_{A} received from the storage region access information identifying unit 53, by submitting the write authority information (UW_{A}, PW_{A}) received from the storage region access information identifying unit 53 so as to store the scanned document D_{A} into the storage region 20A within the file server 20 (S10). Although a write restriction is set for the storage region 20A, storing of the scanned document D_{A} by the document registration unit 55 into the storage region 20A is permitted, because the document registration unit 55 accesses the storage region 20A by submitting the write authority information (UW_{A}, PW_{A}).

In the information terminal 40X, the document access unit 45d monitors the storage region 20A by periodically accessing the storage region 20A, and reads out the scanned document D_{A} from the storage region 20A when the scanned document D_{A} is stored into the storage region 20A (S11). The document access unit 45d stores the acquired scanned document D_{A} within the memory device 42.

The screen control unit 45e monitors the memory device 42, and displays a thumbnail image of the scanned document D_{A} on the display screen of the UI 43 when the scanned document D_{A} is stored into the memory device 42. When the user touches and selects the thumbnail on the display screen of the UI 43, in response to this user operation, the screen control unit 45e allows the scanned document D_{A} to be displayed on the large-size display unit 44 (S12).

As described above, in the conference room X, when the user A holds his IC card 5A over the information terminal 40X and subsequently scans a paper document by means of the scanner 10X, the scanned document D_{A} is automatically loaded into the information terminal 40X, and the thumbnail of the scanned document D_{A} is displayed on the UI 43 of the information terminal 40X. When the user A touches the thumbnail, the image of the scanned document D_{A} is displayed on the large-size display unit 44.

According to the above-described embodiment, the following advantages may be achieved.

(1) According to the present embodiment, a scanner and an information terminal are provided at each of the multiple locations. Subsequent to input of a user identifier of a user in an information terminal provided at a location among the multiple locations, the document transfer server employs scanner access information correlated in advance with that location so as to acquire from the scanner provided at that location a scanned document retained within the scanner. Subsequently, the document transfer server employs storage region access information correlated in advance with the user identifier of that user so as to store the acquired scanned document into the storage region assigned to that user. By virtue of this arrangement of the present embodiment, in an environment in which scanners are provided in multiple locations, a user can use a scanner in any of the multiple locations by performing similar, simple operations in order to digitize a paper document and store the obtained scanned document in his own storage region.

(2) Because scanners and information terminals are provided in multiple conference rooms, a paper document owned by a member can be speedily converted into an electronic document and stored in an accessible storage region during a conference. In particular, when this embodiment of the present invention is applied to an electronic conferencing system, a paper document can be speedily loaded into the electronic conferencing system.

(3) The document transfer server monitors a scanner after a user identifier is input into an information terminal, and acquires a scanned document from the scanner when the scanned document is retained in the scanner. By virtue of this arrangement, the scanned document generated by the scanner can be speedily transferred to the user's storage region. By configuring the document transfer server to start or stop monitoring a scanner in accordance with a user's instructing operation, the monitoring period can be set as desired by the user, thereby enhancing convenience. Furthermore, the monitoring period can thereby be limited to a period during which transfers are required, such that errors in transfer of scanned documents can be prevented and the amount of processing can be reduced.

(4) A read restriction is set for a scanned document retained within each scanner, and read authority information corresponding to the read restriction is included in scanner access information. By virtue of this arrangement, transfer of a scanned document from a scanner to a storage region can be achieved while avoiding the security risk of unauthorized readout of the scanned document from the scanner.

(5) A write restriction is set for each storage region, and write authority information corresponding to the write restriction is included in storage region access information. Accordingly, automatic transfer of a scanned document can be achieved while preventing unauthorized access to the storage region.

(6) The information terminal uses document access information correlated in advance with an input user identifier so as to acquire the scanned document from the storage region assigned to a user denoted by the user identifier. By virtue of this arrangement, when the information terminal is, for example, an electronic conferencing terminal, the scanned document can be instantly employed in an electronic conference. For example, the scanned document can be displayed on the UI screen or large-size display unit of the information terminal immediately after scanning.

(7) A read restriction is set for each storage region, and read authority information corresponding to the read restriction is included in document access information. Accordingly, transfer of a scanned document from a storage region to an information terminal can be achieved while avoiding the security risk of unauthorized readout of the scanned document from the storage region.

### SECOND EMBODIMENT

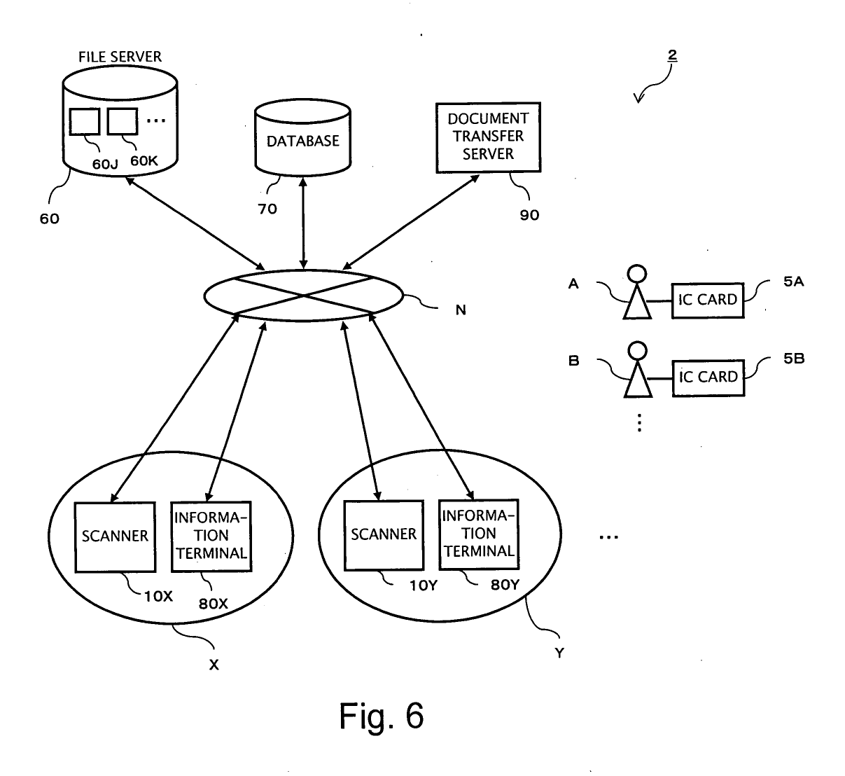

FIG. 6 is a block diagram showing the overall configuration of a document scan system 2 according to a second embodiment of the present invention. As can be seen in FIG. 6, the document scan system 2 has a configuration very similar to that of the above-described document scan system 1. In the following section, features of the document scan system 2 which differ from the document scan system 1 will be described in detail, whereas descriptions of common features will be omitted or simplified. Further, elements identical to those of the document scan system 1 are assigned the same reference numerals.

In FIG. 6, similar to the first embodiment, the document scan system 2 includes scanners 10 provided respectively in multiple locations, a file server 60, a database 70, information terminals 80 provided respectively in the above-noted multiple locations, and a document transfer server 90. In FIG. 6, two conference rooms X and Y are shown as examples of the multiple locations, and these rooms are provided with scanners 10X, 10Y and information terminals 80X, 80Y, respectively. Further, location identifiers RID_{X} and RID_{Y} for identifying the respective locations are assigned to the conference rooms X, Y.

As in the first embodiment, an IC card 5 is issued in advance to each user of the document scan system 2. FIG. 6 shows, as examples, two users A, B owning IC cards 5A, 5B, respectively. User identifiers UID_{A}, UID_{B} are stored in the IC cards 5A, 5B, respectively.

<Scanners>

As in the first embodiment, each scanner 10 is a device which scans an original copy to generate a scanned document and retains the scanned document in its internal memory section. A read restriction is set for the memory section within each scanner 10. User name U_{X} and password P_{X} are set for the scanner 10X, and user name U_{Y} and password P_{Y} are set for the scanner 10Y.

<File Server>

In the present embodiment, the file server 60 includes multiple storage regions allocated to respective conferences. In FIG. 6, a storage region 60J for conference J and a storage region 60K for conference K are shown as examples of the multiple storage regions.

An access restriction for restricting writing and readout of data is set for each storage region. In a cases where the file server 60 has received from an external device a request for accessing a certain storage region, the file server 60 permits access when predetermined access authority information is submitted, and refuses access when this information is not submitted. In the present embodiment, predetermined access authority information for a certain storage region includes any of access authority information assigned to a registered participant of a conference correlated with that storage region. A registered participant of the conference is a user, from among users of the document scan system 2, who is registered in advance as a participant in the conference. Access authority information is assigned in advance to each user.

<Database>

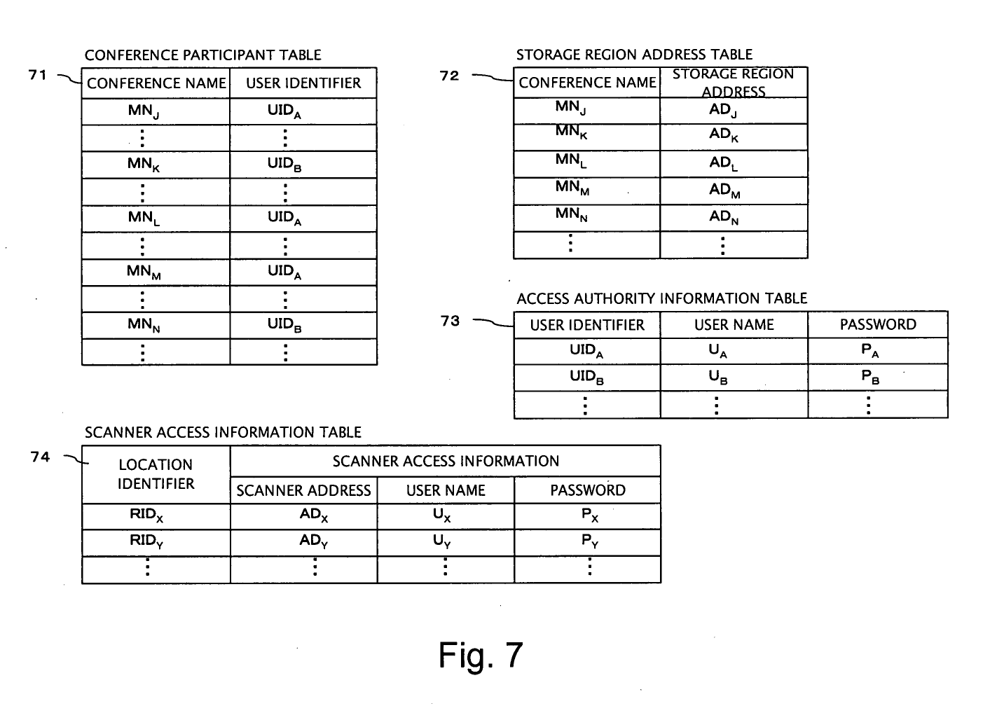

The database 70 stores various data employed in the document scan system 2. FIG. 7 shows tables of data registered in the database 70. According to the present embodiment, the database 70 has stored therein a conference participant table 71, a storage region address table 72, an access authority information table 73, and a scanner access information table 74, as can be seen in FIG. 7.

The conference participant table 71 is a table which shows a correlation between each conference identifier (in the present embodiment, a conference name) for identifying a conference and user identifiers of users who are participants in the conference.

The storage region address table 72 is a table which shows a correlation between each conference name and a corresponding storage region address (such as a URL) denoting a position, on the network, of a storage region allocated to the conference denoted by the conference name.

The access authority information table 73 is a table which shows a correlation between each user identifier and corresponding access authority information assigned to the user denoted by the user identifier. In the present embodiment, access authority information includes a user name and a password.

The scanner access information table 74 is a table which shows a correlation between each location identifier and corresponding scanner access information required for reading out data from the scanner 10 provided at the location denoted by the location identifier. In the present embodiment, the scanner access information includes a scanner address (such as an IP address) denoting the position of the scanner 10 on the network, and read authority information (user name and password) corresponding to the read restriction of the scanner 10.

<Information Terminals>

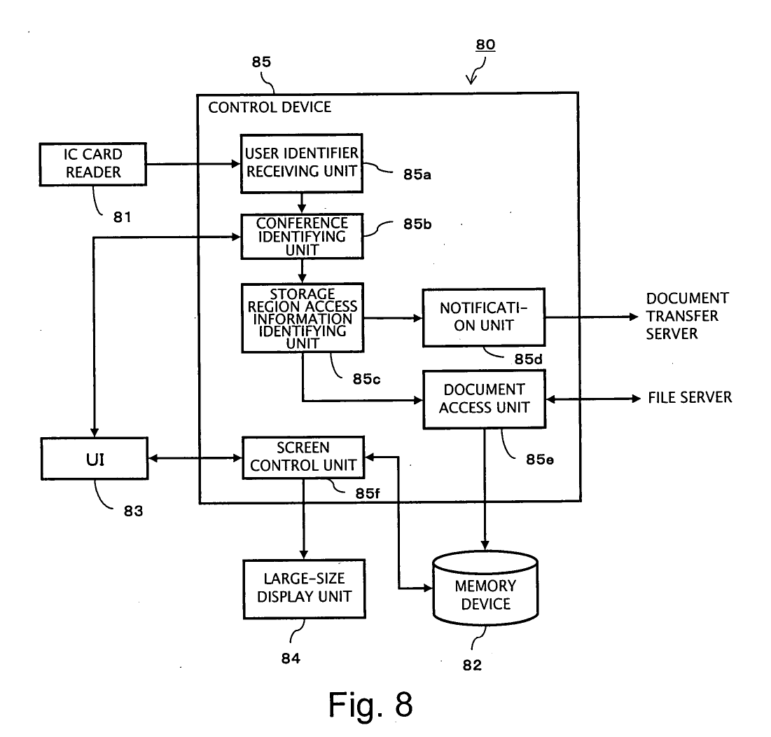

Each information terminal 80 is an information terminal for an electronic conferencing system, and has a configuration shown in FIG. 8. As shown in FIG. 8, the information terminal 80 includes an IC card reader 81, a memory device 82, a UI 83, a large-size display unit 84, and a control device 85. All features other than the control device 85 are identical with those of the first embodiment.

In the present embodiment, the control device 85 includes, as functional blocks, a user identifier receiving unit 85a, a conference identifying unit 85b, a storage region access information identifying unit 85c, a notification unit 85d, a document access unit 85e, and a screen control unit 85f.

The user identifier receiving unit 85a receives a user identifier read out by the IC card reader 81, and supplies the received user identifier to the conference identifying unit 85b.

Upon receiving the user identifier from the user identifier receiving unit 85a, the conference identifying unit 85b provides, to the user, a display indicating conferences correlated in advance with the user identifier, and receives the user's input for selecting a conference. Specifically, the conference identifying unit 85b refers to the conference participant table 71 within the database 70 so as to extract conference names correlated to the received user identifier. The extracted conference names are displayed on the screen of the UI 83, and the user's operation for selecting a conference name is performed on this screen. The conference identifying unit 85b supplies the selected conference name along with the user identifier to the storage region access information identifying unit 85c.

The storage region access information identifying unit 85c identifies storage region access information which is correlated in advance with the conference name or the user identifier received from the conference identifying unit 85b. In the present embodiment, the storage region access information identifying unit 85c refers to the storage region address table 72 within the database 70 so as to identify the storage region address correlated with the received conference name. Furthermore, the storage region access information identifying unit 85c refers to the access authority information table 73 so as to identify the access authority information corresponding to the received user identifier. The identified storage region address and access authority information are supplied as the storage region access information to the notification unit 85d and the document access unit 85e.

The notification unit 85d transmits to the document transfer server 90 the storage region access information received from the storage region access information identifying unit 85c along with a location identifier assigned to the location at which the information terminal 80 is placed. The location identifier is assumed to have been registered in advance in a predetermined memory section inside the information terminal 80.

Upon receiving the storage region access information (including the storage region address and the access authority information) from the storage region access information identifying unit 85c, the document access unit 85e uses the storage region access information to acquire from the file server 60 a scanned document stored therein. Specifically, at predetermined timings, the document access unit 85e submits the access authority information to the storage region denoted by the storage region address so as to access the storage region, and acquires a scanned document when the scanned document is stored in the accessed storage region. For example, after receiving the storage region access information, the document access unit 85e monitors the storage region by periodically accessing the storage region, and acquires the scanned document when the scanned document is stored into the storage region. In an embodiment, the document access unit 85e starts or stops monitoring the storage region in accordance with an instructing operation of the UI 83 by the user. It should be noted that the timing, frequency, duration, or the like at which the document access unit 85e accesses the storage region can be set as appropriate. The document access unit 85e stores the scanned document acquired from the storage region into the memory device 82.

The screen control unit 85f allows the scanned document stored in the memory device 82 to be displayed on the large-size display unit 84. In the present embodiment, the screen control unit 85f first controls the UI 83 to display a screen prompting the user to select which of one or more scanned documents stored within the memory device 82 should be displayed on the large-size display unit 84, receives the user's input for selecting a scan document via this screen on the UI 83, and causes the large-size display unit 84 to display the selected scanned document. The screen control unit 85f may be configured to display a scanned document on the large-size display unit 84 immediately after completion of the process for storing the scanned document into the memory device 82.

<Document Transfer Server>

The document transfer server 90 is a server which transfers a scanned document retained within each scanner 10 to a storage region allocated to a conference within the file server 60.

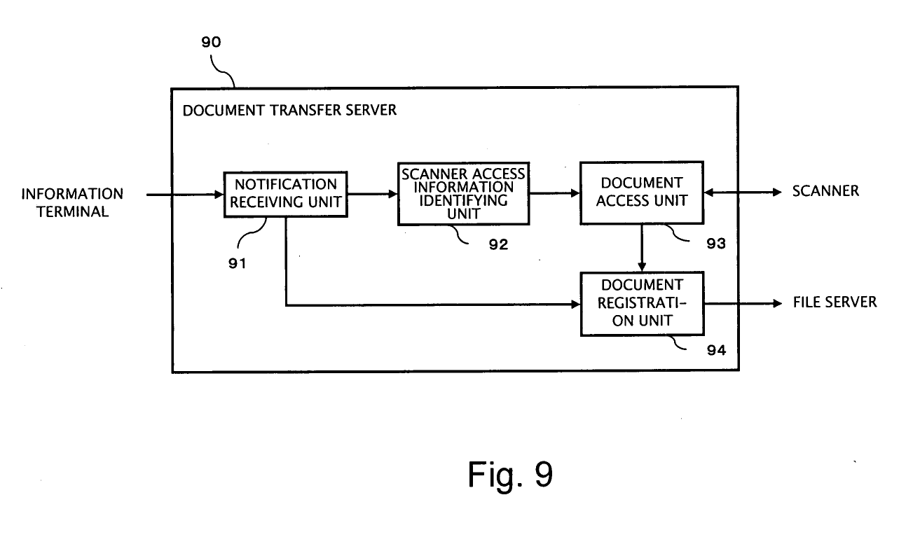

FIG. 9 is a block diagram showing the configuration of the document transfer server 90. As shown in FIG. 9, the document transfer server 90 includes, as functional blocks, a notification receiving unit 91, a scanner access information identifying unit 92, a document access unit 93, and a document registration unit 94.

The notification receiving unit 91 receives from an information terminal 80 notification of storage region access information and a location identifier. In turn, the notification receiving unit 91 supplies the location identifier to the scanner access information identifying unit 92, while supplying the storage region access information to the document registration unit 94.

The scanner access information identifying unit 92 identifies scanner access information correlated in advance with the location identifier received from the notification receiving unit 91. In the present embodiment, the scanner access information identifying unit 92 refers to the scanner access information table 74 within the database 70 so as to identify the scanner access information corresponding to the location identifier. The scanner access information identifying unit 92 supplies the identified scanner access information to the document access unit 93.

After receiving the scanner access information (including a scanner address and read authority information), the document access unit 93 uses the scanner access information to acquire from the scanner 10 a scanned document retained therein. Specifically, at predetermined timings, the document access unit 93 submits the read authority information to the scanner 10 denoted by the scanner address so as to access the scanner 10, and acquires a scanned document when the scanned document is retained in the accessed scanner 10. For example, after receiving the scanner access information, the document access unit 93 monitors the scanner 10 by periodically accessing the scanner 10, and acquires the scanned document when the scanned document is stored into the scanner 10. In an embodiment, the document access unit 93 starts or stops monitoring the scanner 10 in accordance with an instructing operation of the UI 83 by the user. It should be noted that the timing, frequency, duration, or the like at which the document access unit 93 accesses the scanner 10 can be set as appropriate. The document access unit 93 supplies the scanned document acquired from the scanner 10 into the document registration unit 94.

The document registration unit 94 uses the storage region access information (including a storage region address and access authority information) received from the notification receiving unit 91 to store the scanned document acquired by the document access unit 93 into the file server 60. Specifically, the document registration unit 94 submits the access authority information to the storage region denoted by the storage region address, so as to access the storage region and store the scanned document therein.

<Operation of Document Scan System>

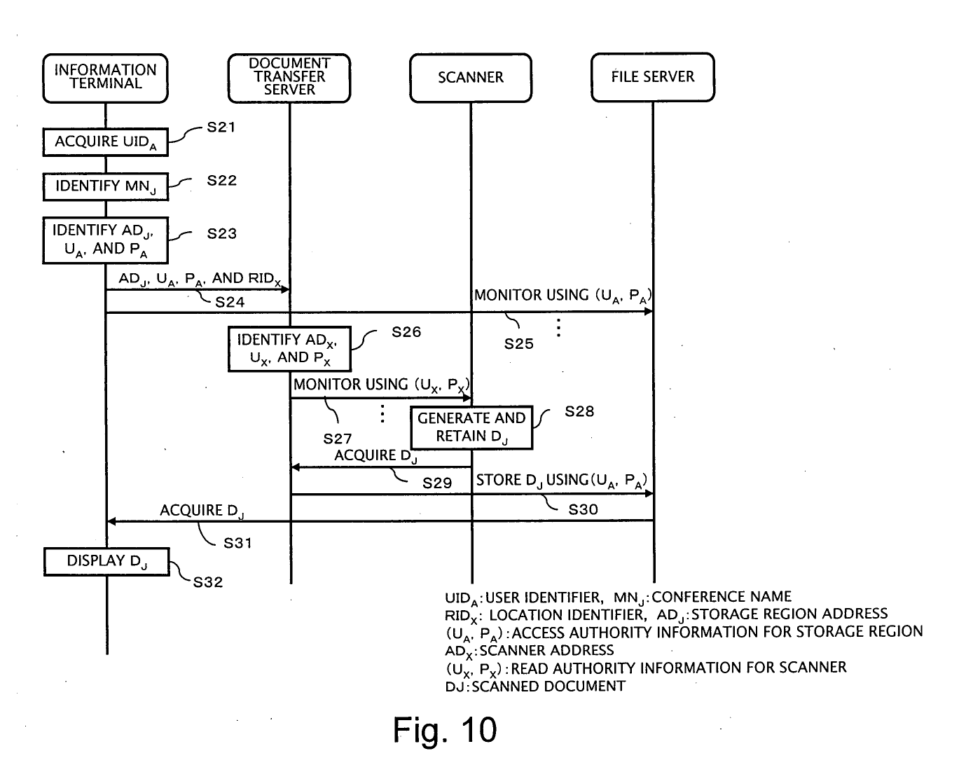

FIG. 10 is a flowchart showing an operation sequence of the document scan system 2. FIG. 10 illustrates a case in which the user A begins the conference J in the conference room X and employs the scanner 10X. The operation of the document scan system 2 is described in detail below with reference to FIG. 10.

When the conference J is to be held in the conference room X, the user A, who is a speaker in the conference, first holds his IC card 5A over the IC card reader 81 of the information terminal 80X placed in the conference room X.

In the information terminal 80X, when the IC card 5A is held over the IC card reader 81, the user identifier receiving unit 85a acquires via the IC card reader 81 the user identifier UID_{A} stored in the IC card 5A (S21). The user identifier receiving unit 85a then supplies the user identifier UID_{A} to the conference identifying unit 85b.

When receiving the user identifier UID_{A}, the conference identifying unit 85b refers to the conference participant table 71 within the database 70, and extracts conference names (in the present example, MN_{J}, MN_{L}, and MN_{M}) correlated with the user identifier UID_{A}. The conference identifying unit 85b then displays the extracted conference names on the screen of the UI 83 so as to prompt the user to select a conference. In the present example, because the user A is holding the conference J, the user A touches and selects the conference name MN_{J} on the screen of the UI 83. The conference identifying unit 85b receives this input selecting the conference name MN_{J} (S22). Subsequently, the conference identifying unit 85b supplies the selected conference name MN_{J}, along with the user identifier UID_{A}, to the storage region access information identifying unit 85c.

When receiving the above-noted information (MN_{J}, UID_{A}) from the conference identifying unit 85b, the storage region access information identifying unit 85c refers to the storage region access information table 72 within the database 70, and acquires a storage region address AD_{J} corresponding to the conference name MN_{J}. In addition, the storage region access information identifying unit 85c refers to the access authority information table 73, and acquires access authority information (U_{A}, P_{A}) corresponding to UID_{A} (S23). The acquired storage region address AD_{J} and access authority information (U_{A}, P_{A}) are supplied as the storage region access information to the notification unit 85d and the document access unit 85e.

When receiving the storage region access information (AD_{J}, U_{A}, P_{A}), the notification unit 85d transmits to the document transfer server 90 the received information along with the location identifier RID_{X} registered in advance in the information terminal 80X (S24).

Meanwhile, upon receiving the storage region access information (AD_{J}, U_{A}, P_{A}), the document access unit 85e starts periodically accessing the storage region 60J denoted by the storage region address AD_{J} (S25). This accessing process involves submitting the access authority information (U_{A}, P_{A}) to the storage region 60J.

In the document transfer server 90, upon receiving the storage region access information (AD_{J}, U_{A}, P_{A}) and the location identifier RID_{X} from the information terminal 80X, the notification receiving unit 91 supplies the location identifier RID_{X} to the scanner access information identifying unit 92, and supplies the storage region access information (AD_{J}, U_{A}, P_{A}) to the document registration unit 94.

When receiving the location identifier RID_{X}, the scanner access information identifying unit 92 refers to the scanner access information table 74, and acquires scanner access information (AD_{X}, U_{X}, P_{X}) corresponding to the location identifier RID_{X} (S26). The acquired scanner access information is supplied to the document access unit 93.

Upon receiving the scanner access information (AD_{X}, U_{X}, P_{X}), the document access unit 93 starts periodically accessing the scanner 10X denoted by the scanner address AD_{X} (S27). This accessing process involves submitting the read authority information (U_{X}, P_{X}) to the scanner 10X.

During the conference, when it is desired to display a paper document owned by a participant in the conference on the large-size display unit 84 of the information terminal 80X, the user A sets the paper document on the scanner 10X and presses the scan start button (not shown) of the scanner 10X. In response, the scanner 10X reads the image of the paper document set thereon so as to generate a scanned document D_{J}, and stores the scanned document D_{J} within the internal memory section (S28).

In the document transfer server 90, the document access unit 93 monitors the scanner 10X by periodically accessing the scanner 10X, and reads out the scanned document D_{J} from the scanner 10X when the scanned document D_{J} is stored into the scanner 10X (S29). Although a read restriction is set for the memory section of the scanner 10X, readout of the scanned document D_{J} by the document access unit 93 is permitted, because the document access unit 93 accesses the scanner 10X by submitting the read authority information (U_{X}, P_{X}). The document access unit 93 supplies the acquired scanned document D_{J} to the document registration unit 94.

Upon receiving the scanned document D_{J}, the document registration unit 94 accesses the storage region 60J, which is denoted by the storage region address AD_{J} received from the notification receiving unit 91, by submitting the access authority information (U_{A}, P_{A}) received from the notification receiving unit 91 so as to store the scanned document D_{J} into the storage region 60J (S30). Although an access restriction is set for the storage region 60J, storing of the scanned document D_{J} by the document registration unit 94 into the storage region 60J is permitted, because the document registration unit 94 accesses the storage region 60J by submitting the access authority information (U_{A}, P_{A}) of the user A who is a registered participant in the conference J.

In the information terminal 80X, the document access unit 85e monitors the storage region 60J by periodically accessing the storage region 60J, and reads out the scanned document D_{J} from the storage region 60J when the scanned document D_{J} is stored into the storage region 60J (S31). The document access unit 85e stores the acquired scanned document D_{J} within the memory device 82.

The screen control unit 85f monitors the memory device 82, and displays a thumbnail image of the scanned document D_{J} on the display screen of the UI 83 when the scanned document D_{J} is stored into the memory device 82. In response to the user touching and selecting the thumbnail on the display screen of the UI 83, the screen control unit 85f allows the scanned document D_{J} to be displayed on the large-size display unit 84 (S32).

As described above, in the conference room X, when the user A holds his IC card 5A over the information terminal 80X, selects the conference J, and subsequently scans a paper document by means of the scanner 10X, the scanned document D_{J} is automatically loaded into the information terminal 80X, and the thumbnail of the scanned document D_{J} is displayed on the UI 83 of the information terminal 80X. When the user A touches the thumbnail, the image of the scanned document D_{J} is displayed on the large-size display unit 84.

When ending the conference J, the user A touches an “end conference” button displayed on the UI 83 of the information terminal 80X. In response, the information terminal 80X ceases monitoring the storage region 60J, and notifies the document transfer server 90 of the end of the conference J such that the document transfer server 90 ceases the document transfer processing. Furthermore, the information terminal 80X registers the scanned document displayed on the large-size display unit 84 into a predetermined memory region such as the storage region 60J while attaching conference information including the conference name, conference time and date, and participants in the conference, thereby creating minutes of the conference J.

According to the above-described embodiment, the following advantage is achieved in addition to those similar to the advantages (1)-(7) attained in the first embodiment.

(8) According to the above-described embodiment, the scanned document displayed on the display unit of the electronic conferencing system is stored into a predetermined memory region while conference information is attached to the scanned document. With this arrangement, workload required for creating minutes of the conference can be reduced, thereby enhancing convenience.

It should be noted that the present invention is not limited to the above-described embodiments, and that various modifications can be made without deviating from the scope of the present invention.

For example, although an IC card is employed for user authentication in the above-described embodiments, a combination of user name and password or biometric information may alternatively be used. In other words, the reading of the IC card by the IC card reader may be replaced by an operation such as manual input of a user name and a password or reading of fingerprint feature information by a fingerprint sensor.

Further, although the scanner retains the scanned document inside a memory section located within the scanner in the above-described embodiments, the scanner may be configured to retain the scanned document inside an externally-provided memory section.

Moreover, although the information terminal automatically downloads the scanned document from the file server in the above-described embodiments, the path for acquiring the scanned document from the file server is not limited to this form. For example, the user may acquire the scanned document by accessing the file server using a PC other than the information terminal.

Further, use of the read restriction of the memory section of the scanner, the write restriction of the storage region, or the read restriction of the storage region may be omitted as appropriate.

Although embodiments of the present invention have been described with a certain degree of particularity using specific examples, it is to be understood that the invention is not limited thereto. It is further understood by those skilled in the art that various changes and modifications may be made in the invention without departing from the spirit and scope thereof.

According to an aspect of the present invention, there is provided a document scan system, having: scanners, provided in a plurality of locations, that scan a document to generate and store an electronic document; information terminals, provided in the plurality of locations, that receive an input of a user identification information for identifying the user; a document access unit that, subsequent to input of a user identification information into an information terminal, acquires an electronic document from a scanner provided at a location in which the information terminal is provided; and a document registration unit that stores the electronic document acquired by the document access unit into a storage region assigned to a user indicated by the user identification information.

According to another aspect of the present invention, the plurality of locations may be a plurality of conference rooms.

According to another aspect of the present invention, the document scan system may further include a conference identifying unit that, when a user identification information is input into an information terminal provided in a conference room, displays information of one or more conferences correlated with the user identification information, and receives an input for selecting a conference; wherein the document registration unit stores the electronic document into a storage region assigned to the conference.

According to another aspect of the present invention, the document access unit may monitor the scanner after the user identification information is input, and when the electronic document is stored in the scanner, acquire the electronic document.

According to another aspect of the present invention, the document access unit may start or stop monitoring of the scanner in accordance with an instructing operation by the user.

According to another aspect of the present invention, a read restriction may be set for the electronic document stored in the scanner; and the document access unit may acquire the electronic document using read authority information correlated with the location.

According to another aspect of the present invention, a write restriction may be set for the storage region; and the document registration unit may store the electronic document using write authority information correlated with the user.

According to another aspect of the present invention, the information terminal may acquire the electronic document from the storage region using document access information correlated with the user identification information.

According to another aspect of the present invention, the information terminal may acquire the electronic document from the storage region using document access information correlated with the conference.

According to another aspect of the present invention, a read restriction may be set for the storage region; and the document access information may include read authority information required for acquiring the electronic document from the storage region.

According to another aspect of the present invention, a read restriction may be set for the storage region; and the document access information may include read authority information required for acquiring the electronic document from the storage region.

According to another aspect of the present invention, the information terminal may display the electronic document acquired from the storage region on a display unit of an electronic conferencing system.

According to another aspect of the present invention, the information terminal may display the electronic document acquired from the storage region on a display unit of an electronic conferencing system.

According to another aspect of the present invention, the electronic document displayed on the display unit may be stored in a memory region with conference information including a name, time, or participants of a conference.

According to another aspect of the present invention, the electronic document displayed on the display unit may be stored in a memory region with conference information including a name, time, or participants of a conference.

According to another aspect of the present invention, the information terminal may read out the user identification information from an IC card owned by the user by means of an IC card reader.

According to another aspect of the present invention, there is provided a document scan system, having: scanners, provided in a plurality of locations, that scan a document to generate and store an electronic document; information terminals, provided in the plurality of locations, that receive an input of user identification information for identifying a user; a document transfer unit that transfers an electronic document stored in a scanner to a storage region assigned to a user; a scanner access information table that shows a correlation between a location and scanner access information which is required for acquiring an electronic document stored in a scanner provided at the location; and a storage region access information table that shows a correlation between user identification information and storage region access information which is required for storing an electronic document into a storage region assigned to a user indicated by the user identification information; wherein the information terminal notifies the document transfer unit of information of a location in which the information terminal is provided, along with the input user identification information; and the document transfer unit acquires, from a scanner provided in the location indicated by the notified information, an electronic document stored in the scanner based on the scanner access information which is acquired according to the scanner access information table, and stores the acquired electronic document into a storage region assigned to a user indicated by the notified user identification information, based on the storage region access information which is acquired according to the storage region access information table.

According to another aspect of the present invention, there is provided a document transfer system that transfers an electronic document stored in a scanner in an environment in which scanners are provided in a plurality of locations, the system having: information terminals, provided in the plurality of locations, that receive a user identification information for identifying the user; a document acquiring unit that, subsequent to input of a user identification information into an information terminal, acquires an electronic document from a scanner provided at a location in which the information terminal is provided; and a document registration unit that stores the acquired electronic document into a storage region assigned to a user indicated by the user identification information.

According to another aspect of the present invention, there is provided a document transfer method for transferring an electronic document stored in a scanner in an environment in which scanners are provided in a plurality of locations, the method having: receiving, via information terminals provided in the plurality of locations, a user identification information for identifying a user; subsequent to input of a user identification information into an information terminal, acquiring, from a scanner provided at a location in which the information terminal is provided, an electronic document; and storing the acquired electronic document into a storage region assigned to a user indicated by the user identification information.

According to another aspect of the present invention, there is provided a storage medium readable by a computer, the storage medium storing a program of instructions executable by the computer to perform a function for transferring an electronic document stored in a scanner in an environment in which scanners are provided in a plurality of locations, the function having: receiving, via information terminals provided in the plurality of locations, a user identification information for identifying a user; subsequent to input of a user identification information into an information terminal, acquiring, from a scanner provided at a location in which the information terminal is provided, an electronic document; and storing the acquired electronic document into a storage region assigned to a user indicated by the user identification information.

What is claimed is:

1. A document scan system, comprising:
scanners, provided in a plurality of locations, that scan a document to generate and store an electronic document;
information terminals, provided in the plurality of locations, that receive an input of a user identification information for identifying the user;
a document access unit that, subsequent to input of a user identification information into an information terminal, acquires an electronic document from a scanner provided at a location in which the information terminal is provided; and
a document registration unit that stores the electronic document acquired by the document access unit into a storage region assigned to a user indicated by the user identification information.

2. The document scan system according to claim 1, wherein the plurality of locations are a plurality of conference rooms.

3. The document scan system according to claim 2, further comprising:
a conference identifying unit that, when a user identification information is input into an information terminal provided in a conference room, displays information of one or more conferences correlated with the user identification information, and receives an input for selecting a conference; wherein
the document registration unit stores the electronic document into a storage region assigned to the conference.

4. The document scan system according to claim 1, wherein the document access unit monitors the scanner after the user identification information is input, and when the electronic document is stored in the scanner, acquires the electronic document.

5. The document scan system according to claim 4, wherein the document access unit starts or stops monitoring of the scanner in accordance with an instructing operation by the user.

6. The document scan system according to claim 1, wherein a read restriction is set for the electronic document stored in the scanner; and
the document access unit acquires the electronic document using read authority information correlated with the location.

7. The document scan system according to claim 1, wherein a write restriction is set for the storage region; and
the document registration unit stores the electronic document using write authority information correlated with the user.

8. The document scan system according to claim 1, wherein the information terminal acquires the electronic document from the storage region using document access information correlated with the user identification information.

9. The document scan system according to claim 3, wherein the information terminal acquires the electronic document from the storage region using document access information correlated with the conference.

10. The document scan system according to claim 8, wherein a read restriction is set for the storage region; and
the document access information includes read authority information required for acquiring the electronic document from the storage region.

11. The document scan system according to claim 9, wherein a read restriction is set for the storage region; and
the document access information includes read authority information required for acquiring the electronic document from the storage region.

12. The document scan system according to claim 8, wherein the information terminal displays the electronic document acquired from the storage region on a display unit of an electronic conferencing system.

13. The document scan system according to claim 9, wherein the information terminal displays the electronic document acquired from the storage region on a display unit of an electronic conferencing system.

14. The document scan system according to claim 12, wherein the electronic document displayed on the display unit is stored in a memory region with conference information including a name, time, or participants of a conference.

15. The document scan system according to claim 13, wherein the electronic document displayed on the display unit is stored in a memory region with conference information including a name, time, or participants of a conference.

16. The document scan system according to claim 1, wherein the information terminal reads out the user identification information from an IC card owned by the user by means of an IC card reader.

17. A document scan system, comprising:
scanners, provided in a plurality of locations, that scan a document to generate and store an electronic document;
information terminals, provided in the plurality of locations, that receive an input of user identification information for identifying a user;
a document transfer unit that transfers an electronic document stored in a scanner to a storage region assigned to a user;
a scanner access information table that shows a correlation between a location and scanner access information which is required for acquiring an electronic document stored in a scanner provided at the location; and
a storage region access information table that shows a correlation between user identification information and storage region access information which is required for storing an electronic document into a storage region assigned to a user indicated by the user identification information; wherein
the information terminal notifies the document transfer unit of information of a location in which the information terminal is provided, along with the input user identification information; and
the document transfer unit acquires, from a scanner provided in the location indicated by the notified information, an electronic document stored in the scanner based on the scanner access information which is acquired according to the scanner access information table, and stores the acquired electronic document into a storage region assigned to a user indicated by the notified user identification information, based on the storage region access information which is acquired according to the storage region access information table.

18. A document transfer system that transfers an electronic document stored in a scanner in an environment in which scanners are provided in a plurality of locations, the system comprising:
information terminals, provided in the plurality of locations, that receive a user identification information for identifying the user;
a document acquiring unit that, subsequent to input of a user identification information into an information terminal, acquires an electronic document from a scanner provided at a location in which the information terminal is provided; and
a document registration unit that stores the acquired electronic document into a storage region assigned to a user indicated by the user identification information.

19. A document transfer method for transferring an electronic document stored in a scanner in an environment in which scanners are provided in a plurality of locations, the method comprising:
receiving, via information terminals provided in the plurality of locations, a user identification information for identifying a user;
subsequent to input of a user identification information into an information terminal, acquiring, from a scanner provided at a location in which the information terminal is provided, an electronic document; and
storing the acquired electronic document into a storage region assigned to a user indicated by the user identification information.

20. A storage medium readable by a computer, the storage medium storing a program of instructions executable by the computer to perform a function for transferring an electronic document stored in a scanner in an environment in which scanners are provided in a plurality of locations, the function comprising:
receiving, via information terminals provided in the plurality of locations, a user identification information for identifying a user;
subsequent to input of a user identification information into an information terminal, acquiring, from a scanner provided at a location in which the information terminal is provided, an electronic document; and
storing the acquired electronic document into a storage region assigned to a user indicated by the user identification information.
